(19) United States
(12) Patent Application Publication
(10) Pub. No.: US 2008/0034554 A1
(43) Pub. Date: Feb. 14, 2008

(54) Soft handle

(76) Inventor: Chin Sung Ko, Ho Mei Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/487,383

(22) Filed: Jul. 17, 2006

(51) Int. Cl. B25G 1/10

(52) U.S. Cl. 16/430

(57) ABSTRACT

The invention relates to an improved soft handle, which includes a soft shell and a central rod with a top cap and a bottom cap. Liquid is filled in the space between the shell and the rod. The shell has a bottom upward end, which is put around the rod. And the rod has an annual groove and a ring to clip and fix the upward end of the shell on the rod to prevent from any leakage of liquid for keeping utilization of the handle.

### BACKGROUND OF THE INVENTION

A traditional handle is covered with a leather or rubber skin for providing a soft feeling when users hold it. But it is not good enough. An improved soft handle is designed recently, which includes a soft shell and a central rod. A top cap and a bottom cap are connected with both ends of the rod and the shell that forms an inner space therebetween. Liquid is then filled into the space. This improvement can though provide a better soft effect when users hold it but the sealing between the rod and the shell may be sometimes failed, especially after a period time of use or a sudden heavy holding. Liquid leaks away and the handle will be useless.

The present invention is to provide a new improved soft handle to overcome the drawback of said known structure. The improved handle includes a shell having a special configuration with a perfect engaging structure with its inner rod that prevents from leakage of liquid. Now, accompanying with the following drawings, the character of the present invention will be described here and after.

### BRIEF DESCRIPTION OF THE DRAWINGS

FIG. 1 is an exploded perspective view showing an improved soft handle according to the present invention.

FIG. 2 is an assembled view of FIG. 1.

FIG. 3 is a cross-sectional plan view of FIG. 2.

FIG. 4 is a plan view showing filling liquid into the handle according to the present invention.

### DETAILED DESCRIPTION OF THE PREFERRED EMBODIMENT

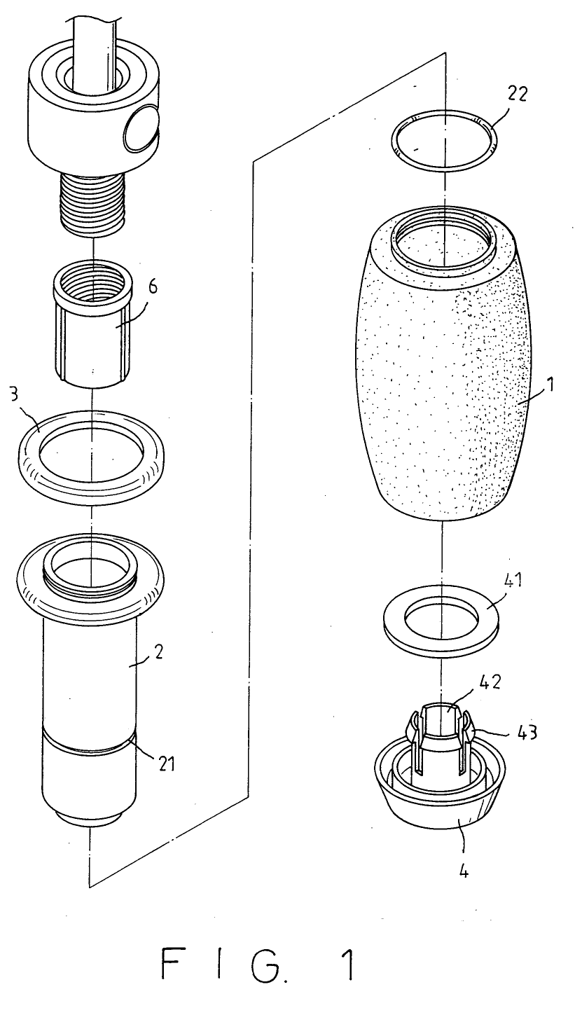

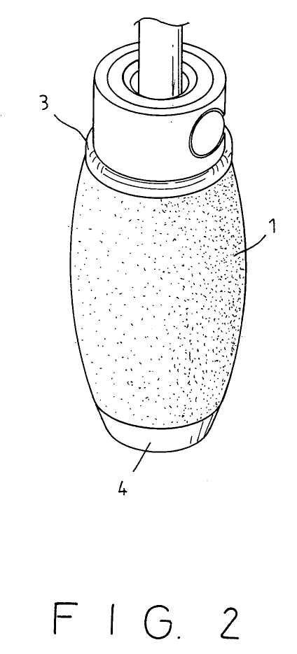

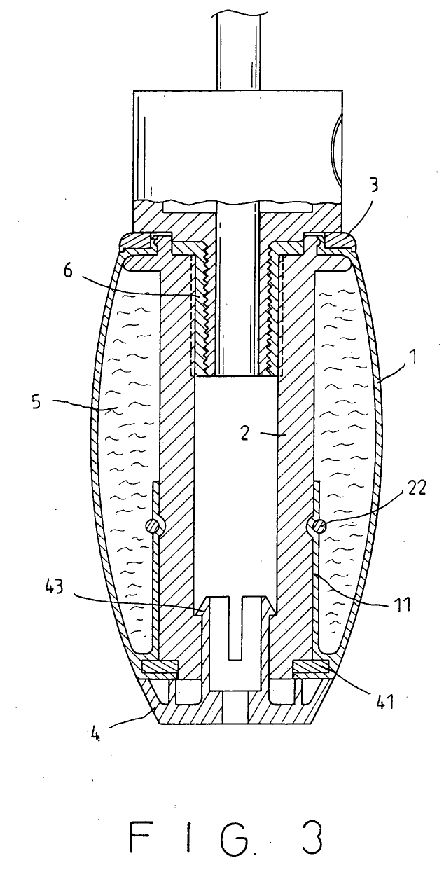

Please refer to FIG. 1 to 3; the present invention includes a soft shell (1) and a central rod (2) with a top cap (3) and a bottom cap (4). Liquid (5) is filled in the space between the shell (1) and the rod (2). The character of the present invention is that the shell (1) has a bottom upward end (11), which is put around the rod (2). The rod (2) has an annual groove (21) and a ring (22) to clip and fix the upward end (11) of the shell (1) on the rod (2). Under this engagement, liquid (5) in the handle will never leak and this overcomes the drawback of prior art.

Furthermore, the present invention can provide a washer (41) around the bottom cap having several upward elastic slices (42) with end hook (43). The central rod (2) is provided with an inner step end for engagement with each hook (43) that completes a simple connection between the bottom cap (4) and the rod (2). A connector (6) can also be provided in top end of the central rod (2) for connecting with other objects, such as a lower end of an umbrella. Hence, the soft handle of this invention becomes an excellent handle of an umbrella.

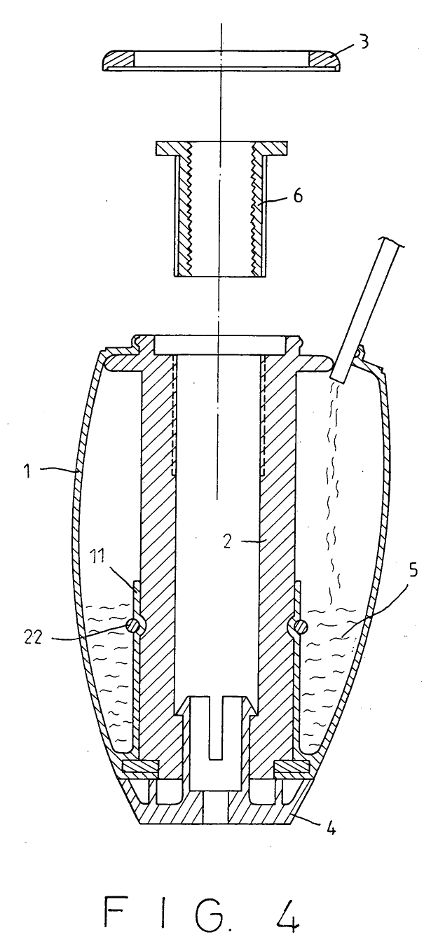

Referring to FIG. 4, it shows an easy procedure by just pulling a top end of the shell (1) sideward for filling liquid (5) into the space between the shell (1) and the rod (2).

Accordingly, the present invention has the improved effect and should be allowed for a patent. It is also to be understood that the above-mentioned embodiments are only exemplary of the present invention. Any modification with the same or similar merit is still claimed in this application.

I claim:

1. An improved soft handle including a soft shell and a central rod with a top cap and a bottom cap, liquid filled in the space between the shell and the rod; the character is that the shell having a bottom upward end, which is put around the rod, wherein the rod has an annual groove and a ring to clip and fix the upward end of the shell on the rod.

2. The improved soft handle as claimed in claim 1, wherein a washer is provided around the bottom cap having several upward elastic slices with end hook and the central rod is provided with an inner step end for engagement with each hook that completes a simple connection between the bottom cap and the rod.
